(19) United States
(12) Patent Application Publication
(10) Pub. No.: US 2026/0371165 A1
(43) Pub. Date: Nov. 19, 2026

(54) INTELLIGENT ROUTING OF SHORT CODES

(71) Applicant: T-Mobile USA, Inc., Bellevue, WA (US)

(72) Inventor: Shewangizaw Gebremariam, Seattle, WA (US)

(21) Appl. No.: 19/207,096

(22) Filed: May 13, 2025

(51) Int. Cl. H04W 28/084; H04W 4/14

(52) U.S. Cl. CPC H04W 28/084; H04W 4/14

(57) ABSTRACT

Systems and methods for providing USSD services by a service provider handling USSD short code requests originating from user equipment configured for the service provider or another service provider are described herein. When a service provider receives a USSD short code from an originating device on a cellular network provided by the service provider, the USSD short code is sent to a USSD server. The USSD server is configured to query a data store to determine which service provider the USSD short code is associated with. The query is performed to configure the USSD server to send the USSD short code to the application server that services USSD short codes for a particular service provider. The USSD short code is provided to the application server and the data resulting from the USSD short code service call is provided to the originating device.

### BACKGROUND

Cellular networks often allow the use of unstructured supplementary service data (USSD) service calls by their subscribers. USSD is widely used in various applications due to its ability to offer a nearly direct and instantaneous communication channel. Unlike short messaging service (SMS) messages, which may encounter delays due to a store-and-forward approach often used by SMS services, USSD can provide a continuous, real-time link, allowing users to interact with services without interruptions. This capability can be advantageous for time-sensitive services where immediate feedback may be needed. The simplicity of USSD can also contribute to its effectiveness. USSD often does not require Internet access, making USSD accessible to a broader range of users, including those with basic mobile phones. This characteristic can be important in regions where smartphone adoption may be low or where internet connectivity is limited or unreliable. The short codes used are often specific to a particular network or service provider. USSD codes used for a service on one network may not be the same as USSD codes used for the same service on another network.

The presently disclosed subject matter is directed to aspects of improving disadvantages of current USSD implementations.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of an illustrative wireless network environment in which the disclosed systems and techniques may be implemented, in accordance with examples of the disclosure.

FIG. 2 is a diagram of an illustrative signal flow associated with providing USSD services by a service provider handling USSD short code requests originating from user equipment configured for the service provider or another service provider, in accordance with examples of the presently disclosed subject matter.

FIG. 3 shows a flow diagram of an illustrative process for providing USSD services by a service provider handling USSD short code requests originating from user equipment configured for the service provider or another service provider, in accordance with examples of the presently disclosed subject matter.

FIG. 4 is an example schematic of a computing device for use with the systems and methods disclosed herein, in accordance with some examples of the present disclosure.

### DETAILED DESCRIPTION

This disclosure is generally directed to systems, methods, and apparatuses for providing USSD services by a cellular network handling USSD service calls originating from user equipment configured for use in the cellular network or other cellular networks. In some examples of the presently disclosed subject matter, user equipment may be configured to operate within a particular service provider. The codes used for USSD services may be particular to that service provider, whereas the code for the same service may be different for a different service provider. For example, an example code may be #777#for a service on a service provider that the user equipment is originally configured to work on. The same code, e.g., #777#, may be a USSD code that is for a different service on another service provider (or network). Thus, if a user equipment is switched to operate on another service provider, a user entering and causing to be transmitted the code for the service may end up receiving the wrong service or be denied a service because the code is different on the new network or new service provider.

This situation, whereby a user equipment configured for use on one network/service provider is now being handled on a different network/service provider, can occur for various reason. One reason may be the absorption of the service provider by another service provider as may occur in a merger or acquisition of service providers. In some cases, a service provider, or carrier, may allow the utilization of its network infrastructure by another carrier, or a mobile virtual network operator (MVNO). As used herein and in the following description, a “service provider” can refer to service providers that provide cellular service and provide the network infrastructure for use by its customers or service providers that use another service provider's network infrastructure (e.g. an MVNO).

In some examples, as mentioned above, each service provider may create, define, and develop unique USSD codes for its own customers. The non-standard nature of USSD codes may cause issues. For example, some issues may include: an extended time to market because developing individual short codes for each service provider can slow down the deployment of services, delaying time to market; higher development costs due to the need to create separate end-to-end solutions for each service provider; issues with customer confusion because a USSD code used in one service provider may be different in another service provider, requiring a customer to remember codes across multiple service providers; excessive network traffic by using the wrong USSD codes; and inefficient flow management due to customizing and redesigning service flows for each service provider now being serviced by one or more other service providers.

Thus, in some examples, prior to routing a service call when receiving a USSD code, a service provider queries the USSD code to determine which service provider the short code is used for. It should be noted that although the following description and examples may be directed to the receipt of USSD codes used for an MVNO, the presently disclosed subject matter is not limited to that implementation, as the examples are merely to illustrate an example implementation of the presently disclosed subject matter. The receiving service provider queries a USSD code data store. The USSD code data store may be one or more data stores used by the receiving service provider or one or more data stores for the MVNO accessible by the receiving service provider. The USSD service provider data store has stored therein a list of UE identifiers, and the service providers to which the UE identifiers are associated with. In other examples, the USSD service provider data store has stored therein a list of USSD short codes and the service provider to which each USSD short code is associated with. Once the service provider of the USSD short code is identified, the USSD service of the receiving service provider is configured to direct the USSD short code to the application server associated with the identified service provider.

The systems and methods discussed herein are discussed generally with respect to cellular UEs, tablets, computers, wearable devices, and the like, and in terms of components (e.g., network entities) associated with Wi-Fi networks, Bluetooth networks, wired networks, fourth generation (4G) and fifth generation (5G) cellular networks using terrestrial and satellite base stations, and other types of networks. The systems and methods can be used with other types of equipment and on other types of networks, however, where users may wish to have increased flexibility in sending and receiving calls, video calls, and messages. Thus, the systems and methods described herein are described in terms of 4G or 5G networks merely because these networks represent the state of the current art. One of skill in the art will recognize, however, the systems and methods could also be used on other networks such as sixth generation (6G) and other current and future networks.

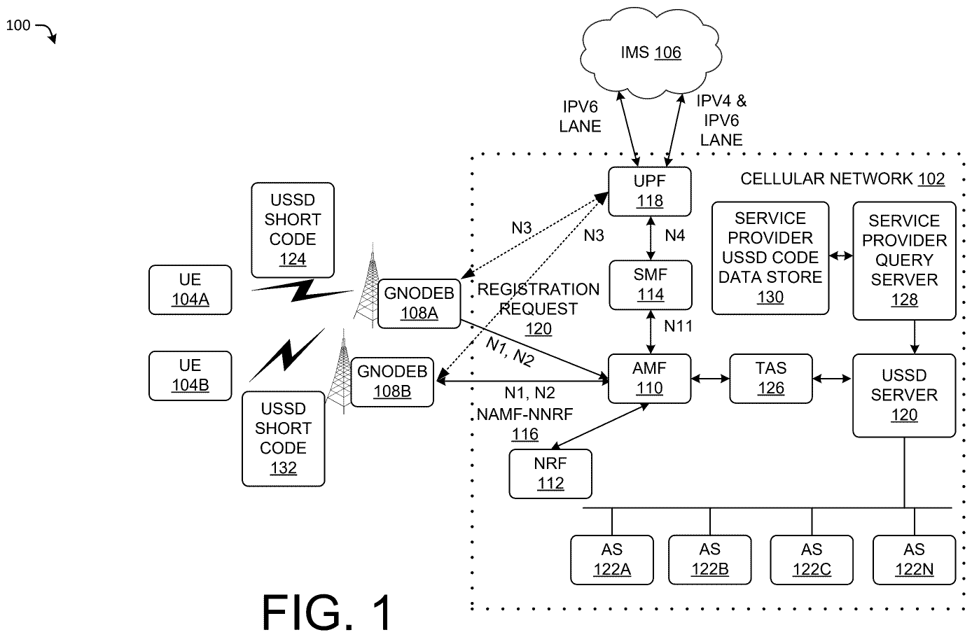

FIG. 1 is a schematic diagram of an illustrative wireless network environment 100 in which the disclosed systems and techniques may be implemented, in accordance with examples of the disclosure. The environment 100 may include a cellular network 102. The cellular network 102 may be a network implemented by a first service provider that can be used by one or more second service providers, such as an MVNO. The cellular network 102 may include various types of networks that support the communication of one or more user equipment (UE) 104A/104B (hereinafter referred to generically and collectively as “the UE 104,” and individually as “the UE 104A,” and “the UE 104B”) using the cellular network 102. It should be noted that although the UE 104 are illustrated as having wireless connections, the UE 104 may be wired and wireless, and may also be part of a network such as an enterprise network (not shown). The UE 104 may be devices such as computer, mobile cellular phones, cellular home Internet devices, tracker devices, and the like. The cellular network 102 may be one or more mobile telecommunication networks that facilitate communications between devices of various types, such as computing device and mobile devices (e.g., UEs). Various connections between devices in the cellular network 102 may be wired, wireless, or a combination thereof. The cellular network 102 may facilitate packet-based communications between the UE 104 and devices on the Internet and/or one or more Internet Protocol Multimedia Systems (IMSs), such as IP multimedia system or subsystem (IMS) 106. In the example described below, the UE 104A is associated with a first service provider that provides the cellular network 102 and the UE 104B is associated with an MVNO that, through a subscription plan, allows its subscribers, such as the UE 104B, to use the cellular network 102.

The cellular network 102 may include networks that support one or more 3GPP standards, including, but not limited to, Long Term Evolution (LTE) networks (e.g., 4G LTE networks) and New Radio (NR) networks (e.g., 5G NR networks). However, the disclosed systems and techniques may be applicable in any network or system in which the UE 104 may request and receive access to communicate with network and/or remote devices using any protocol. A UE 104 may access the IMS 106 using protocols such as IPv4 and IPv6. A request for an IPv4v6 communications connection from the device (also known as a “dual stack” connection) may indicate that the UE 104 supports both IPv4 and IPv6. Such a UE 104 may prefer to use IPv6 but is able to use IPv4 in the event that an IPv6 connection is not available.

Communication between the UE 104 and the cellular network 102 may be provided through the use of one or more base stations, represented in FIG. 1 by gNodeB 108A and 108B (hereinafter referred to generically as “the gNodeB 108,” and individually as “the gNodeB 108A” and “the gNodeB 108B”). While referred to as a “gNodeB” for explanatory purpose herein, the gNodeB 108 may be any type of base station, including, but not limited to, any type of base transceiver station (BTS), NodeB, eNodeB, gNodeB, and the like. The gNodeB 108 may communicate with other devices and elements in the core of the cellular network 102. The gNodeB 108 is an example of an asset that is installed at a fixed or relatively fixed geographic location to service the UE 104 in the cell provided by the gNodeB 108.

Once the UE 104 has been registered with the cellular network 102 through the gNodeB 108, the UE 104 can access services provided by the IMS 106 through the gNodeB 108 by establishing a protocol data unit (PDU) session at the cellular network 102. A PDU session, for example in a 5G network, may be an end-to-end communications session between a device (e.g., the UE 104) and a data network (e.g., the IMS 106). The gNodeB 108 may relay or otherwise convey this PDU session request from the UE 104 to an access management function (AMF) 110 in the core of the wireless network in which the gNodeB108 or the satellite 109 is configured. The AMF 110 may interact with one or more other components to perform the operations needed to establish this session, such as authenticating the device and/or user, registering the UE 104 with the cellular network 102.

The AMF 110, based on receiving this request for the establishment of a PDU, i.e., an IPv4-type or IPv6-type session on behalf of the UE 104, may query a new radio function (NRF) 112 for an address (e.g., IP address) for a session management function (SMF) 114 with which it may interact to establish the requested PDU session. The AMF 110 may exchange SMF discovery communications 116 (Namf−Nnrf), which may be called an SMF address request in some examples, with the NRF 112. The NRF 112 returns the identifier of the SMF 114 for use by the AMF 110. Thereafter, the AMF 110 sends a connection request N11 to the selected SMF 114. In examples, the SMF 114 may provide the access information needed by the UE 104 to communicate with a data network using the established session.

The SMF 114 provides this information to the AMF 110 for relay to the gNodeB 108 and ultimately to the UE 104 requesting the PDU session. In 5G examples, a message that provides such information may be referred to as a “N1N2MessageTransfer.” These and other messages communicating similar information may be referred to generally herein as a “message transfer” messages. The SMF 114 further establishes a connection to its coordinating user plane function (UPF) 118 through an N4 interface, which facilitates communications between the UE 104 and the IMS 106. The SMF 114 generates a connection N3 from the gNodeB 108 or the satellite 109 to the UPF 118 to provide a communication path between the UE 104, through the gNodeB 108 or the satellite 109, and to and from the IMS 106 through either the IPv6 or the IPv4&IPv6 lane.

As noted above, a service provided by the cellular network 102 is USSD, which is handled by a USSD server 120. The USSD server 120 receives a USSD short code and transmits that USSD short code that is to be handled by one of application servers (AS) 122A-122N (hereinafter referred to generically as “the AS 122,” and individually as “the AS 122A,” “the AS 122B,” and so forth). As used herein, the AS 122 is a platform where USSD applications are hosted and managed. The USSD server 120 can act as a bridge between the cellular network 102 and external applications or services, enabling interactive communication with the UE 104 even without internet access. The AS 122 are accessed when the AMF 110 receives a USSD short code 124 from one of the UE 104, such as the UE 104A. The AMF 110 routes the USSD short code 124 to a telephony application server (TAS) 126. In some examples, the TAS 126 is a server that handles certain call processing, as establishing, maintaining, and terminating phone calls, as all well supplementary services such as routing USSD short code 124 to the USSD server 120.

As noted above, the cellular network 102 may be required or configured to handle USSD short code calls from other service providers. To illustrate this example, the AS 122A and AS 122B are application servers for the service provider of the cellular network 102, the AS 122C is an application server for a second service provider whose users are allowed to use the cellular network 102, and the AS 122N is an application server that handles generic USSD short codes that are independent of a specific service provider's AS 122.

To determine which AS 122 the USSD server 120 is to send the USSD short code 124 to a service provider query server 128 receives the USSD short code 124. The USSD short code 124 as received by the service provider query server 128 has an associated UE identifier that identifies the originating UE that sent the USSD short code. The service provider query server 128 accesses a service provider data store 130 to determine the service provider to which the USSD short code 124 is associated. The service provider data store 130 has stored therein a list of UE identifiers, such as an mobile station international subscriber directory number (MSISDN) or an international mobile subscriber identity (IMSI) number, and the service provider to which each UE is associated. For example, the service provider query server 128 queries the service provider data store 130 with the corresponding UE identifier that is associated with the USSD short code 124. Accordingly, the service provider query server 128 may obtain an identity of the service provider that is associated with the received USSD short code 124 based on the UE identifier associated with the received USSD short code 124. As additional service providers are added to the service providers that use the cellular network 102 to handle network traffic, the service provider data store 130 can be updated. It should be noted that in some examples, the service provider data store 130 may be a separate data store or may be part of other components of the cellular network 102 such as one or more subscriber databases, home subscriber servers, and the like. Once the service provider query server 128 receives the service provider that is associated with the received USSD short code 124, the service provider query server 128 provides the identification of the service provider to the USSD server 120. The USSD server is then configured, using the identification of the service provider provided by the service provider query server 128, to provide the USSD short code 124 to the appropriate AS 122. For example, the service provider query server 128 may identify the service provider of the cellular network 102 to be associated with the USSD short code 124 and provide the USSD short code 124 to AS 122A or AS 122B. In another example, the service provider query server 128 may identify an MVNO that is associated with a USSD short code 132 transmitted by UE 104B, and thus, provide the USSD short code 132 to the AS 122C. The AS 122 returns data relating to the USSD short code.

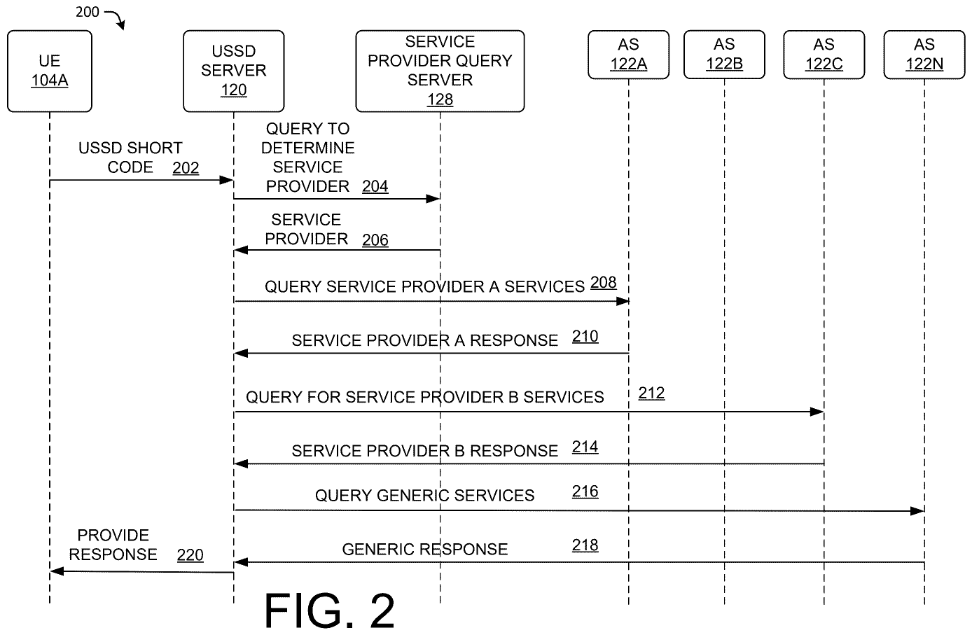

FIG. 2 is a diagram of an illustrative signal flow associated with providing USSD services by a service provider handling USSD short code requests originating from user equipment configured for the service provider or another service provider, in accordance with examples of the presently disclosed subject matter. As shown in FIG. 2, at 202, the UE 104A transmits a USSD short code to the USSD server 120, as described above with respect to FIG. 1 by way of example. Specifically, in the present example, the AMF 110 routes the USSD short code 124 to the TAS 126, which in turn routes the USSD short code to the USSD server.

When the USSD server 120 receives the USSD short code at 202, the USSD server 120 may be unaware of which service provider whose traffic is being handled on cellular network the USSD short code is associated with. In some prior systems, the USSD server 120 may simply route the USSD short code to the AS 122A and/or the AS 122B, the application servers associated with the service provider providing and operating the cellular network 102. If this is done, in some examples, the wrong data may be returned or the USSD short code call may come back as an error or simply not returned. In the presently disclosed subject matter, to try to avoid those and other issues of prior systems, prior to routing the USSD short code to any application server, the USSD server 120 at 204 transmits a query to determine the service provider of the USSD short code to the service provider query server 128. The service provider query server 128 accesses the service provider data store 130. The service provider data store 130 has stored therein a list of USSD short codes and the service provider to which each USSD short code is associated with.

At 206, the service provider query server 128 receives the service provider that is associated with the received USSD short code 124 from the service provider data store 130. At this point in the signal flow, the USSD server 128 is configured to communicate via query 208 to the AS 122A/122B of one service provider, via query 212 to the AS 122C of another service provider, or via query 216 to a generic AS 122N that handles USSD short codes that are not service provider dependent (e.g., common, standard, or not associated with any service providers). If the AS 122A receives the query 208, the AS 122A provides a response to the query at 210. If the AS 122C receives the query 212, the AS 122C provides a response to the query at 214. If the AS 122N receives the query 216, the AS 122N provides a response to the query at 218. The response from the particular AS is provided to the UE at 220.

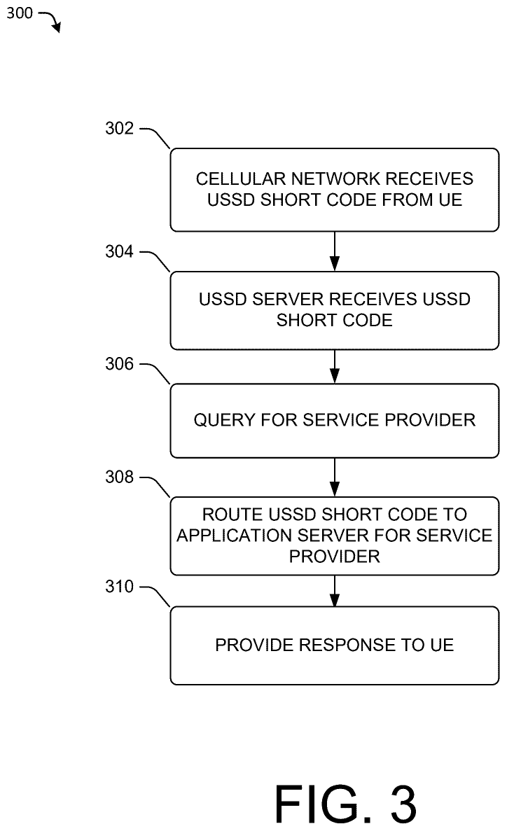

FIG. 3 shows a flow diagram of an illustrative process 300 for providing USSD services by a service provider handling USSD short code requests originating from user equipment configured for the service provider or another service provider, in accordance with examples of the presently disclosed subject matter. The process 300 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 300 may be described with reference to the wireless network environment 100 of FIG. 1, however other environments may also be used.

At block 302, the cellular network 102 receives the USSD short code 124 from the UE 104A. At block 304, the USSD server 120 receives the USSD short code 124. The AMF 110 routes the USSD short code 124 to the TAS 126, which in turn routes the USSD short code to the USSD server.

At block 306, the USSD server 120 queries the service provider query server 128 to determine which service provider is associated with the USSD short code 124. As mentioned above, when the USSD server 120 receives the USSD short code at 304, the USSD server 120 may be unaware of which service provider whose traffic is being handled on cellular network the USSD short code is associated with. In the presently disclosed subject matter, to try to avoid errors associated with routing a USSD short code 124 to an incorrect AS 122, prior to routing the USSD short code to any application server, the USSD server 120 transmits a query to determine the service provider of the USSD short code to the service provider query server 128. The service provider query server 128 accesses the service provider data store 130 to determine the service provider that the UE identifier, such as an MSISDN or IMSI, is associated with. As mentioned above, in some other examples, the USSD short code 124, if unique to a particular service provider, may be used to determine the service provider.

At block 308, after receiving the identity of the service provider associated with the USSD short code 124, the USSD server 120 provides the USSD short code 124 to the AS 122 associated with the identified service provider. At block 310, the data generated by the AS 122 that received and processed the USSD short code 124 is returned to the UE 104A.

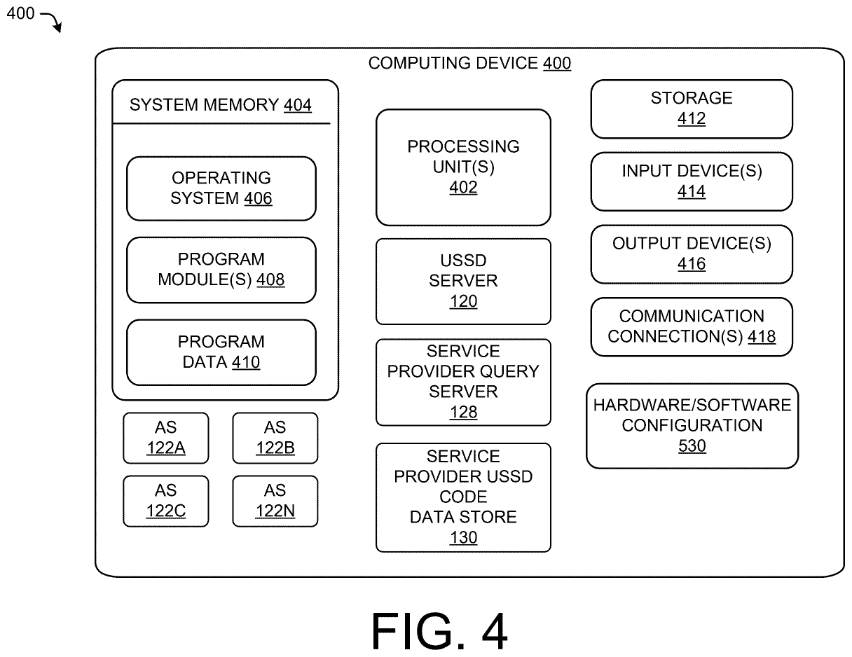

FIG. 4 is an example schematic of a computing device 400 for use with the systems and methods disclosed herein, in accordance with some examples of the present disclosure. The computing device 400 can be one or more computing devices used to implement various components of a core network, a base station, and/or any servers, routers, gateways, gateway elements, administrative components, etc. that can be used by a communication provider. The computing device 400 can further be one or more computing devices used to implement the cellular network 102, the USSD server 120, the AS 122, the service provider query server 128, and/or the service provider data store 130, and other components of the cellular network 102.

In various embodiments, the computing device 400 can include one or more processing units 402 and system memory 404. Depending on the exact configuration and type of computing device, the system memory 404 can be volatile (such as RAM), non-volatile (such as ROM, flash memory, etc.) or some combination of the two. The system memory 404 can include an operating system 406, one or more program modules 408, and can include program data 410. The system memory 404 may be secure storage or at least a portion of the system memory 404 can include secure storage. The secure storage can prevent unauthorized access to data stored in the secure storage. For example, data stored in the secure storage can be encrypted or accessed via a security key and/or password. The program modules can include instructions to execute the USSD server 120, the AS 122, the service provider query server 128, and/or the service provider data store 130, and other components of the cellular network 102.

The computing device 400 can also include additional data storage devices (removable and/or non-removable) such as, for example, magnetic disks, optical disks, or tape. Such additional storage is illustrated in FIG. 4 by storage 412.

Non-transitory computer storage media of the computing device 400 can include volatile and nonvolatile, removable and non-removable media implemented in any method or technology for storage of information, such as computer readable instructions, data structures, program modules, or other data such as the hardware/software configurations. The system memory 404 and storage 412 are examples of computer readable storage media. Non-transitory computers readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information, and which can be accessed by computing device 400. Any such non-transitory computer readable storage media can be part of the computing device 400.

In various embodiments, any or all of the system memory 404 and storage 412 can store programming instructions which, when executed, implement some or all of the functionality described above as being implemented by one or more systems configured in the environment 100 and/or components of the cellular network 102.

The computing device 400 can also have one or more input devices 414 such as a keyboard, a mouse, a touch-sensitive display, voice input device, etc. The computing device 400 can also have one or more output devices 416 such as a display, speakers, a printer, etc. can also be included. The computing device 400 can also contain one or more communication connections 418 that allow the device to communicate with other computing devices using wired and/or wireless communications.

### Example Clauses

The following paragraphs describe various examples. Any of the examples in this section may be used in combination(s) with any other of the examples in this section and/or any of the other examples or embodiments described herein.

A: All methods, systems, and apparatuses, including all equivalents and combinations, disclosed herein, as well as the following example clauses in various combinations.

Clause 1. A method, comprising: receiving, from a user equipment (UE) at a cellular network operated by a first service provider, an unstructured supplementary service data (USSD) short code, wherein the cellular network is configured to handle network traffic for the first service provider and a second service provider; providing, by the cellular network, the USSD short code to a USSD server; querying, by the USSD server, a service provider query server to determine which of the first service provider or the second service provider the USSD short code is associated with; configuring the USSD server to route the USSD short code to a first application server for the first service provider or a second application server for the second service provider based on the determining that the USSD short code is associated with the first service provider or the second service provider; and providing, by the USSD server, the USSD short code to the first application server for the first service provider or the second application server for the second service provider based on configurating the USSD server to route the USSD short code to a first application server for the first service provider or a second application server for the second service provider.

Clause 2. The method of clause 1, further comprising transmitting data to the user equipment relating to the USSD short code from the first application server or the second application server.

Clause 3. The method of clause 1, wherein querying, by the USSD server, the service provider query server to determine which of the first service provider or the second service provider the USSD short code is associated with comprises accessing a service provider data store, wherein the service provider data store comprises a list of UE identifiers and a service provider associated with each of the UE identifiers or a list of USSD short codes and a service provider to which each of the USSD short codes in the list is associated with.

Clause 4. The method of clause 1, wherein the second service provider is a mobile network virtual operator.

Clause 5. The method of clause 1, wherein the cellular network is further configured to handle network traffic for a plurality of third service providers.

Clause 6. The method of clause 1, further comprising a generic USSD short code application server configured to handle generic USSD short codes that are independent of a specific service provider.

Clause 7. The method of clause 1, further comprising updating a service provider USSD code data store when a third service provider is added as one of the service providers using the cellular network to handle network traffic.

Clause 8. A non-transitory computer-readable media storing computer-executable instructions that, when executed by one or more processors, cause the one or more processors to perform operations comprising: receiving, from a user equipment at a cellular network operated by a first service provider, an unstructured supplementary service data (USSD) short code, wherein the cellular network is configured to handle network traffic for the first service provider and a second service provider; providing, by the cellular network, the USSD short code to a USSD server; querying, by the USSD server, a service provider query server to determine which of the first service provider or the second service provider the USSD short code is associated with; configuring the USSD server to route the USSD short code to a first application server for the first service provider or a second application server for the second service provider based on the determining that the USSD short code is associated with the first service provider or the second service provider; and providing, by the USSD server, the USSD short code to the first application server for the first service provider or the second application server for the second service provider based on configurating the USSD server to route the USSD short code to a first application server for the first service provider or a second application server for the second service provider.

Clause 9. The non-transitory computer-readable media of clause 8, further comprising computer-executable instructions to cause the one or more processors to perform operations comprising transmitting data to the user equipment relating to the USSD short code from the first application server or the second application server.

Clause 10. The non-transitory computer-readable media of clause 8, wherein the computer-executable instructions for querying, by the USSD server, the service provider query server to determine which of the first service provider or the second service provider the USSD short code is associated with comprises computer-executable instructions to cause the one or more processors to perform operations comprising accessing a service provider data store, wherein the service provider data store comprises a list of UE identifiers and a service provider associated with each of the UE identifiers or a list of USSD short codes and a service provider to which each of the USSD short code in the list is associated with.

Clause 11. The non-transitory computer-readable media of clause 8, wherein the second service provider is a mobile network virtual operator.

Clause 12. The non-transitory computer-readable media of clause 8, wherein the cellular network is further configured to handle network traffic for a plurality of third service providers.

Clause 13. The non-transitory computer-readable media of clause 8, further comprising a generic USSD short code application server configured to handle generic USSD short codes that are independent of a specific service provider.

Clause 14. The non-transitory computer-readable media of clause 8, further comprising computer-executable instructions to cause the one or more processors to perform operations comprising updating the service provider data store when a third service provider is added as a service provider using the cellular network to handle network traffic.

Clause 15. A network, comprising: a memory storing computer-executable instructions; and one or more processors in communication with the memory, the computer-executable instructions causing the processor to perform acts comprising: receiving, from a user equipment at a cellular network operated by a first service provider, an unstructured supplementary service data (USSD) short code, wherein the cellular network is configured to handle network traffic for the first service provider and a second service provider; providing, by the cellular network, the USSD short code to a USSD server; querying, by the USSD server, a service provider query server to determine which of the first service provider or the second service provider the USSD short code is associated with; configuring the USSD server to route the USSD short code to a first application server for the first service provider or a second application server for the second service provider based on the determining that the USSD short code is associated with the first service provider or the second service provider; and providing, by the USSD server, the USSD short code to the first application server for the first service provider or the second application server for the second service provider based on configurating the USSD server to route the USSD short code to a first application server for the first service provider or a second application server for the second service provider.

Clause 16. The network of clause 15, further comprising computer-executable instructions to cause the one or more processors to perform operations comprising transmitting data to the user equipment relating to the USSD short code from the first application server or the second application server.

Clause 17. The network of clause 15, wherein the computer-executable instructions for querying, by the USSD server, the service provider query server to determine which of the first service provider or the second service provider the USSD short code is associated with further comprises computer-executable instructions to cause the one or more processors to perform operations comprising accessing a service provider data store, wherein the service provider data store comprises a list of UE identifiers and a service provider associated with each of the UE identifiers or a list of USSD short codes and a service provider to which each of the USSD short code in the list is associated with.

Clause 18. The network of clause 15, wherein the second service provider is a mobile network virtual operator.

Clause 19. The network of clause 15, wherein the cellular network is further configured to handle network traffic for a plurality of third service providers.

Clause 20. The network of clause 15, further comprising computer-executable instructions to cause the one or more processors to perform operations comprising updating the service provider data store when a third service provider is added as one of the service providers using the cellular network to handle network traffic.

While the example clauses described above are described with respect to one particular implementation, it should be understood that, in the context of this document, the content of the example clauses can also be implemented via a method, device, system, computer-readable medium, and/or another implementation. Additionally, any of the examples above can be implemented alone or in combination with any other one or more of the other examples.

### CONCLUSION

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method, comprising:
receiving, from a user equipment (UE) at a cellular network operated by a first service provider, an unstructured supplementary service data (USSD) short code, wherein the cellular network is configured to handle network traffic for the first service provider and a second service provider;
providing, by the cellular network, the USSD short code to a USSD server;
querying, by the USSD server, a service provider query server to determine which of the first service provider or the second service provider the USSD short code is associated with;
configuring the USSD server to route the USSD short code to a first application server for the first service provider or a second application server for the second service provider based on the determining that the USSD short code is associated with the first service provider or the second service provider; and
providing, by the USSD server, the USSD short code to the first application server for the first service provider or the second application server for the second service provider based on configurating the USSD server to route the USSD short code to a first application server for the first service provider or a second application server for the second service provider.

2. The method of claim 1, further comprising transmitting data to the user equipment relating to the USSD short code from the first application server or the second application server.

3. The method of claim 1, wherein querying, by the USSD server, the service provider query server to determine which of the first service provider or the second service provider the USSD short code is associated with comprises accessing a service provider data store, wherein the service provider data store comprises a list of UE identifiers and a service provider associated with each of the UE identifiers or a list of USSD short codes and a service provider to which each of the USSD short codes in the list is associated with.

4. The method of claim 1, wherein the second service provider is a mobile network virtual operator.

5. The method of claim 1, wherein the cellular network is further configured to handle network traffic for a plurality of third service providers.

6. The method of claim 1, further comprising a generic USSD short code application server configured to handle generic USSD short codes that are independent of a specific service provider.

7. The method of claim 1, further comprising updating a service provider USSD code data store when a third service provider is added as one of the service providers using the cellular network to handle network traffic.

8. A non-transitory computer-readable media storing computer-executable instructions that, when executed by one or more processors, cause the one or more processors to perform operations comprising:
receiving, from a user equipment at a cellular network operated by a first service provider, an unstructured supplementary service data (USSD) short code, wherein the cellular network is configured to handle network traffic for the first service provider and a second service provider;
providing, by the cellular network, the USSD short code to a USSD server;
querying, by the USSD server, a service provider query server to determine which of the first service provider or the second service provider the USSD short code is associated with;
configuring the USSD server to route the USSD short code to a first application server for the first service provider or a second application server for the second service provider based on the determining that the USSD short code is associated with the first service provider or the second service provider; and
providing, by the USSD server, the USSD short code to the first application server for the first service provider or the second application server for the second service provider based on configurating the USSD server to route the USSD short code to a first application server for the first service provider or a second application server for the second service provider.

9. The non-transitory computer-readable media of claim 8, further comprising computer-executable instructions to cause the one or more processors to perform operations comprising transmitting data to the user equipment relating to the USSD short code from the first application server or the second application server.

10. The non-transitory computer-readable media of claim 8, wherein the computer-executable instructions for querying, by the USSD server, the service provider query server to determine which of the first service provider or the second service provider the USSD short code is associated with comprises computer-executable instructions to cause the one or more processors to perform operations comprising accessing a service provider data store, wherein the service provider data store comprises a list of UE identifiers and a service provider associated with each of the UE identifiers or a list of USSD short codes and a service provider to which each of the USSD short code in the list is associated with.

11. The non-transitory computer-readable media of claim 8, wherein the second service provider is a mobile network virtual operator.

12. The non-transitory computer-readable media of claim 8, wherein the cellular network is further configured to handle network traffic for a plurality of third service providers.

13. The non-transitory computer-readable media of claim 8, further comprising a generic USSD short code application server configured to handle generic USSD short codes that are independent of a specific service provider.

14. The non-transitory computer-readable media of claim 8, further comprising computer-executable instructions to cause the one or more processors to perform operations comprising updating the service provider data store when a third service provider is added as a service provider using the cellular network to handle network traffic.

15. A network, comprising:
a memory storing computer-executable instructions; and
one or more processors in communication with the memory, the computer-executable instructions causing the processor to perform acts comprising:
receiving, from a user equipment at a cellular network operated by a first service provider, an unstructured supplementary service data (USSD) short code, wherein the cellular network is configured to handle network traffic for the first service provider and a second service provider;
providing, by the cellular network, the USSD short code to a USSD server;
querying, by the USSD server, a service provider query server to determine which of the first service provider or the second service provider the USSD short code is associated with;
configuring the USSD server to route the USSD short code to a first application server for the first service provider or a second application server for the second service provider based on the determining that the USSD short code is associated with the first service provider or the second service provider; and
providing, by the USSD server, the USSD short code to the first application server for the first service provider or the second application server for the second service provider based on configurating the USSD server to route the USSD short code to a first application server for the first service provider or a second application server for the second service provider.

16. The network of claim 15, further comprising computer-executable instructions to cause the one or more processors to perform operations comprising transmitting data to the user equipment relating to the USSD short code from the first application server or the second application server.

17. The network of claim 15, wherein the computer-executable instructions for querying, by the USSD server, the service provider query server to determine which of the first service provider or the second service provider the USSD short code is associated with further comprises computer-executable instructions to cause the one or more processors to perform operations comprising accessing a service provider data store, wherein the service provider data store comprises a list of UE identifiers and a service provider associated with each of the UE identifiers or a list of USSD short codes and a service provider to which each of the USSD short code in the list is associated with.

18. The network of claim 15, wherein the second service provider is a mobile network virtual operator.

19. The network of claim 15, wherein the cellular network is further configured to handle network traffic for a plurality of third service providers.

20. The network of claim 15, further comprising computer-executable instructions to cause the one or more processors to perform operations comprising updating the service provider data store when a third service provider is added as one of the service providers using the cellular network to handle network traffic.
